(19) United States
(12) Patent Application Publication
(10) Pub. No.: US 2005/0189725 A1
(43) Pub. Date: Sep. 1, 2005

(54) Multi-layered seal structure

(76) Inventor: Mark Stephen Edwards, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/013,902

(22) Filed: Dec. 16, 2004

Related U.S. Application Data
(60) Provisional application No. 60/531,709, filed on Dec. 22, 2003.

(51) Int. Cl. F16L 17/03

(52) U.S. Cl. 277/615

(57) ABSTRACT

The present invention relates to a multi-layered seal ring capable of expanding for installation onto a shaft, rod or other cylindrical member, and then once in position, provides a seal as though it were a continuous solid ring allowing for only a minimal amount of leakage over a wide temperature range. More specifically, the present invention relates to first and second annular or non-annular forms having gaps or fractures in their structure, wherein the first and second annular or non-annular forms are affixed to one another.

### CROSS-REFERENCE TO RELATED APPLICATION

This application claims the benefit of U.S. Provisional Application No. 60/531,709, filed Dec. 22, 2003.

### FIELD OF THE INVENTION

The present invention relates to a multi-layered seal ring or other geometric configuration that minimizes, controls or essentially eliminates fluid leakage over a wide range of temperatures.

### BACKGROUND OF THE INVENTION

Sealing rings are used for creating a seal between a shaft or rod and the walls of a bore or cylinder in many types of mechanical devices such as, for example, compressors, pumps, automatic transmissions and power steering devices.

A seal ring generally has an open annular shape and is mounted in the circumferential groove of a shaft or rod (e.g., a piston) that is situated within a cylindrical housing. The normal function of the seal ring is to prevent or control the leakage of fluid across the ring structure from one side to the other, while also allowing the shaft or rod upon which it is disposed to rotate, pulsate or reciprocate within the cylindrical housing.

Several seal ring designs having a joint are described in the industry, wherein the joint allows the seal ring to expand or contract in response to the thermal expansion and/or contraction of the cylindrical member, rod or shaft upon which they are mounted. The joints of these seal rings have a variety of geometric configurations such as, for example, step joints, scarf joints and butt joints. However, thermal expansion and exposure to other forces exerted upon the seal rings during their use causes seal rings using these types of joints have gaps in their structure. These gaps are disadvantageous in that they allow for the excessive leakage of fluid across their structure.

Varying degrees of leakage occur over a range of temperatures, a factor that needs to be taken into account in fluid systems (e.g. automatic transmissions) for proper operation. The wide range of temperatures is observed from initial start-up through the upper portion of the operating temperature range of the mechanical process. For example, fluids such as oil will vary in viscosity in response to changes in temperature, and thus its rate of leakage increases as its viscosity decreases, which could result in a greater rate of leakage. Furthermore, the size of a particular material, for example a metal shaft or rod, also varies with temperature due to thermal expansion, wherein an increase in temperature generally results in an increase in the size of the joint gaps in those seal rings known in the art, which again results in greater leakage.

The industry has taken steps to minimize or eliminate leakage, across seal rings, however, such attempts have proven unsuccessful. By example, the rate of leakage across known joints such as, for example, a micro-cut, step gap or butt gap (and others) is reduced by sizing the seal ring to have a smaller gap at cold temperatures. However, this is problematic because as the ring thermally expands in response to its operating temperature, a completely closed gap may result in the ring binding in the groove or even buckle. The binding or buckling results in premature wear and/or causes the ring to improperly seal, wherein the rate of leakage actually increases, especially with the lower viscosities of higher temperature oil.

Therefore, there is a need within the industry to develop a seal ring that eliminates leakage or only allows for minimal yet controlled amounts of leakage across its structure over a wide range of temperatures. The present invention provides just such a seal ring.

### SUMMARY OF THE INVENTION

The present invention relates to an expandable multi-layered seal ring design or other geometric configuration allowing for its installation onto a shaft, rod or other cylindrical member, wherein the present invention essentially eliminates or allows for only minimal yet controlled leakage over a wide range of operating temperatures.

An embodiment of the present invention relates to a multi-layered seal ring or other geometric configuration comprising:
a.) a first annular or non-annular form having a gap or fracture therein; and
b.) a second annular or non-annular form having a gap or fracture therein, wherein the second annular form is contiguous with or adjoining to the first annular form; and
wherein the at least first and second annular forms are affixed to one another at an affixation zone with an affixing agent.

The present invention also relates to a process for forming a multi-layered seal ring or other geometric configuration comprising:
(i) affixing at least a first annular or non-annular form and second annular or non-annular form to one another at an affixation zone with an affixing agent, wherein the at least first annular or non-annular form is contiguous with (or adjoining to) the second annular or non-annular form.

Other alternatives, modifications and equivalents of the present invention will be or become apparent to one with skill in the art upon examination of the following detailed description. It is intended that all such additional alternatives, modifications and equivalents be included within this description and within the scope of the present invention.

### BRIEF DESCRIPTION OF THE DRAWINGS

FIG. 1 depicts a side view of an embodiment of the multi-layered seal ring according to the present invention.

FIG. 2 depicts an exploded side view of an embodiment of the multi-layered seal ring according to the present invention.

FIG. 3 depicts a side view of an embodiment of the multi-layered seal ring positioned on a rod or shaft.

FIG. 4 depicts a side view of an embodiment of the multi-layered seal ring having a fracture therein.

### DETAILED DESCRIPTION

Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

The multi-layered seal rings according to the present invention can be used in a variety of applications including static, reciprocating and rotating applications to perform a sealing function. The multi-layered seal rings are used in applications where fluids in the form of a liquid or gas are isolated, such that the fluid exerts pressure against the seal ring thereby creating a sealed surface.

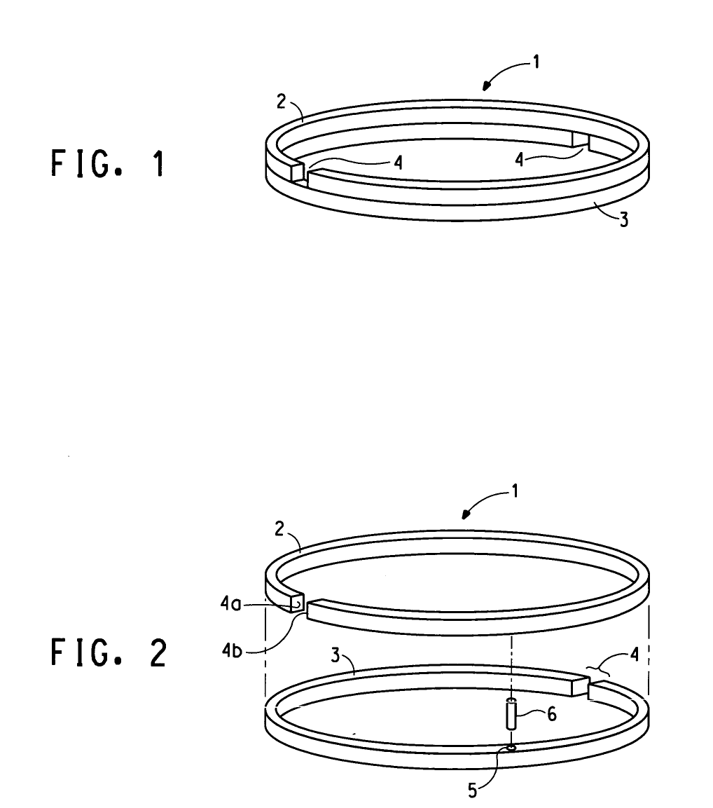

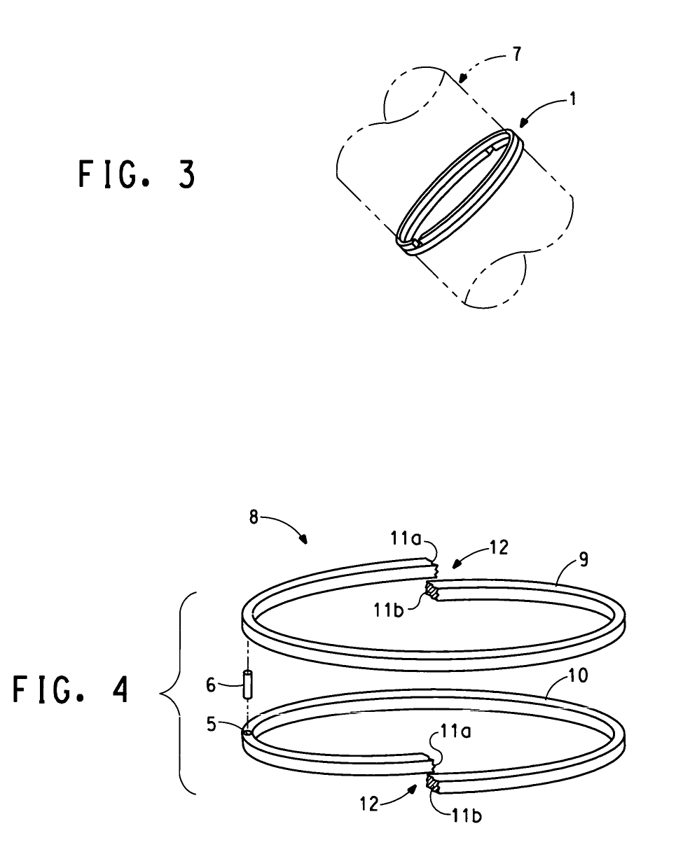

The present invention relates to an expandable multi-layered seal ring design or other geometric configuration thereby allowing its installation onto a shaft, rod or other cylindrical member, and then once in position, provide a seal as though it were a continuous solid ring. Furthermore, the present invention provides for a multi-layered seal ring that essentially eliminates or allows for only minimal yet controlled leakage over a wide range of operating temperatures. More specifically, as shown in FIGS. 1-3, an embodiment of the present invention relates to a multi-layered seal ring (1) comprising:
a.) a first annular form (2) having a gap (4) therein; and
b.) a second annular form (3) having a gap(4) therein, wherein the second annular form is contiguous with or adjoining to the first annular form;
wherein the at least first and second annular forms are affixed to one another at an affixation zone (5) with an affixing agent (6).

The design of the present invention contemplates the use of multiple annular or non-annular forms, wherein at least two individual annular or non-annular forms are connected to one another. For ease of description, an embodiment utilizing two annular forms is set forth herein. Preferably, when only two annular forms are utilized each singular annular form has a thickness that is about one-half as thick as a typical equivalent seal ring.

The at least first and second annular forms of the multi-layered seal ring according to the present invention may generally have a wide range of diameters and still confer its particular advantages.

The at least first (2) and second (3) annular forms according to the present invention may be comprised of any material capable of providing the necessary sealing function while being able to withstand the forces and temperatures generated in the environment in which it is used, for example, metals such as cast iron, flexible elastomers and various polymers. Preferably, the at least first (2) and second (3) annular forms are comprised of polymeric materials, where the first (2) and second (3) annular forms may comprise either the same polymer or different polymers.

A preferred embodiment of the multi-layered seal ring (1) comprises a high performance polymer. More preferably, the present invention comprises a synthetic high performance polymer that is temperature resistant, has a high melting point, has high compressive strength, is not brittle, has a low coefficient of thermal expansion and a low coefficient of friction.

Other physical properties are also important in a seal ring such as, for example, tensile strength, modulus and elongation. Although metal seal rings tend to have better tensile strength and modulus, elongation is higher in polymers. It has been found that for rings of the present invention, tensile strength should be in the range of about 9000 to about 18000 psi (62.1×10³ to 124.1×10³ kPa), elongation in the range of about 2.5% to about 10%, and tensile modulus in the range of about 310,000 to about 750,000 psi (2.14×10⁶ to 5.17×10 kPa). One of ordinary skill in the art would understand that these are merely preferred ranges, but are not limiting. A wide variety of polymers are suitable for use in the multi-layered seal rings (1) in the present invention. Those that are particularly suitable are polyimide, polyamide, polyester, polyether ether ketone (PEEK), polyamide imide (PAI), polyether imide, polyether ketone ketone (PEKK), polyether ketone (PEK), polyphenylene sulfide, polybenzimidazole, and thermoplastic polyimide (TPI), polytetrafluoroethylene (PTFE), and liquid crystal polymer (LCP).

If the polymer is a polyimide, it is preferred that it be prepared from at least one diamine and at least one anhydride. Preferred diamines include m-phenylene diamine (MPD), p-phenylene diamine (PPD), oxydianiline (ODA), methylene dianiline (MDA), and toluene diamine (TDA). Preferred anhydrides include benzophenone tetracarboxylic dianhydride (BTDA), biphenyl dianhydride (BPDA), trimellitic anhydride (TMA), pyromellitic dianhydride (PMDA), maleic anhydride (MA), and nadic anhydride (NA).

Preferred polyimides include those prepared from the following combinations of anhydride and diamine: BTDA-MPD, MA-MDA, BTDA-MDA-NA, TMA-MPD & TMA-ODA, BPDA-ODA, BPDA-MPD, BPDA-PPD, BTDA-4, 4′-diaminobenzophenone, and BTDA-bis(P-phenoxy)-p, p′-biphenyl. An especially satisfactory polyimide useful in the seal ring of present invention is that prepared from pyrometillitic dianhydride and 4,4′-oxydianiline (PMDA-ODA). Even more preferably, the multi-layered seal ring comprises a commercially available polyimide such as, for example, VESPEL® Thermoplastic material (available from E.I. du Pont de Nemours and Company, Wilmington, Del.).

The polyimide compositions can also contain a blend of at least one polyimide with at least one other polymer which is melt processible at a temperature of less than about 400° C. and is selected from polyamide and polyester resin and may be present in a concentration of from about 45 to 79.9 weight percent. Melt processible is used in its conventional sense, that the polymer can be processed in an extrusion apparatus at the indicated temperatures without substantial degradation of the polymer.

A wide variety of polyamides and/or polyesters can be used in the present invention and/or can be blended with polyimides. For example, polyamides, which can be used, include nylon 6, nylon 6,6, nylon 610 and nylon 612. Polyesters, which can be used, include polybutylene terepthalate and polyethylene terepthalate.

A fusible or melt processible polyamide or polyester can additionally be, in the form of a liquid crystal polymer (LCP). LCP's are generally polyesters, including, but not limited to polyesteramides and polyesterimdes. LCP's are described by Jackson et al., for example, in U.S. Pat. Nos. 4,169,933, 4,242,496 and 4,238,600, as well as in “Liquid Crystal Polymers: VI Liquid Crystalline Polyesters of Substituted Hydroquinones.”

The polymers of the multi-layered seal ring (1) of the present invention can further include other additives, fillers and dry lubricants, which do not depreciate the overall characteristics of the finished seal rings, as would be evident to those skilled in the art. For example, the incorporation of graphite into the composition can extend the range of its utility as a wear resistant material. Another beneficial additive is carbon fiber, for the purpose of reducing coefficient of thermal expansion. Various inorganic fillers are known to reduce the coefficient of friction and improve wear resistance. The filler used should not prevent the fracturing of the seal ring in the present invention.

Alternatively, as noted above, the multi-layered seal ring (1) according to the present invention may be comprised of various combinations of polymers, wherein each individual annular form comprises a different polymer. For example, the polymers may be chosen based on their performance and use in varying applications, wherein the wear side of a two-layered ring may comprise a first polymer that provides high wear and low friction characteristics, while the adjoining annular form comprises a more ductile polymer providing for better sealing against a stationary surface. When combinations of polymers are utilized it is preferred to use those polymers having similar thermal expansion rates, preferably within 10% of one another.

The present invention preferably relates to a multi-layered seal ring (1) since rotating equipment frequently draws a substantially circular path. However, a variety of other multi-layered geometric configurations including, but not limited to, multi-layered elliptical sealing structures may be utilized in more specialized applications.

Preferably the individual annular forms according to the present invention have a square or rectangular cross-sectional configuration, however other cross sectional configurations such as, for example, chamfered corners may be used. The chamfer may be an angle or have an inside radius.

The at least first (2) and second (3) annular forms of the present invention have a gap (4) in their structures, which allows the adjoining rings to slide in relation to one another. Thus the gap (4) acts as a “joint” or point of expansion during installation of the present invention for installation purposes. The gaps (4) formed in the multiple annular forms of the present invention are preferably direct formed gaps. As shown in FIGS. 1-3, each individual annular form has a gap (4) through the entirety of its thickness thereby forming a pair of ends having opposing faces (4a, 4b) that are substantially parallel to one another and have smooth faces. Additionally, the gap's opposing faces (4a, 4b) are preferably substantially perpendicular to the major axis or plane of the particular individual annular form.

Alternatively, in place of gaps, the present invention utilizes individual forms that have been fractured as shown in FIG. 4. Each individual annular form is completely fractured (12), through the entirety of its thickness thereby forming a pair of ends having opposing faces (11a, 11b) that are substantially parallel to one another. The fracture's opposing faces (11a, 11b) or the fracture line is preferably substantially perpendicular to the major axis or plane of the particular individual annular form. Generally, the fracture's opposing end faces are rough, and mesh together when the faces are forced into contact, which may further aid in the prevention of leakage.

As is generally known to those of ordinary skill in the art, the multi-layered seal ring (1) becomes heated during the rotational or reciprocating movement of the shaft, rod or other cylindrical member, causing the multi-layered seal ring to thermally expand when the multi-layered seal ring is at operating conditions. For that reason, the opposing end faces (4a, 4b or 1a, 11b) may not necessarily make contact until the operating conditions are reached. It is preferred that the gap (4) or fracture (12) is open at cold temperatures and closed at peak operating temperatures, which minimizes the leakage by the first ring.

The width of the gap (4) is not critical, however its size should not be so large such that when a multi-layered seal ring (1) is formed there is no overlap of the at least first (2) and second (3) annular or non-annular forms. Preferably, the gap width is only a small fraction of the overall circumference measurement of the particular annular form. Additionally, the gap width is generally in linear relation to the diameter of the particular annular form, wherein if the diameter of the individual annular form is doubled, the width of the gap likewise doubles.

Along with temperature, fluid pressure is another operating condition, which affects the multi-layered seal rings' ability to perform the sealing function. When operating pressure is achieved on the pressurized side of the multi-layered seal ring (1) and the operating temperature is achieved, the opposing faces (4a, 4b and 11a, 11b) come together, thereby closing the gap (4) or fracture (12) that was created for installation of the seal ring and whereby the gap or fracture (12) does not become a point of leakage, therefore a single multi-layered seal ring is all that is required to perform the sealing function.

As may be expected, undesirable leakage of fluids across the multi-layered seal ring (1) would be evidence that it is not functioning properly. As mentioned above, in some instances complete removal of leakage is not possible, and in fact, controlled leakage of only minimal amount of fluids is preferred. For example, a controlled leakage may be used for lubrication or heat removal for a bearing or bushing on the non-pressured side such as in a transmission. When the multi-layered seal ring is installed on a shaft or rod used in a bore or cylinder and upon pressurization, a properly functioning multi-layered seal ring will prevent, or at least minimize, leakage of fluids. In a cylinder having a pressurized side upstream of the installed multi-layered seal ring and a non-pressurized side downstream of the seal ring generally functions by isolating the pressurized side from the non-pressurized side.

Moreover, the path of any leaking fluids is typically through the gap (4) or fracture (12) in the first annular form (2), then by way of the interface between the adjoining annular forms until reaching the gap (4) or fracture (12) in the second annular form (3). The length of this pathway between the gaps (4) or fractures (12) of the adjoining annular forms is important in the reduction of the leakage. Therefore the longer the pathway, the better the corresponding reduction in fluid leakage. Accordingly, the gap (4) or fracture (12) may be positioned anywhere along the individual annular forms, as long as these gaps (4) or fractures (12) are not in alignment with one another when the multi-layered seal ring is formed. The gaps (4) or fractures (12) in the multi-layered seal ring may be positioned in close proximity with one another for ease of assembling on a shaft, rod or other cylindrical member (7), thereby shortening the leakage pathway; however there will be an increase in the leakage volume. It is preferred that the gaps (4) or fractures (12) are substantially opposite one another, more preferably about 180 degrees apart, thereby eliminating or minimizing the amount of leakage.

The advantages conferred by the gaps or fracture (12) in the multi-layered seal ring (1) of the present invention are negated when the individual annular forms rotate relative to one another, resulting in alignment of the gaps (4) or fracture (12) on the shaft, rod or other cylindrical member (7). Therefore, the at least first (2) and second annular (3) forms are affixed to one another at an affixation zone (5) using an affixing agent (6) to prevent the rotation relative to one another, as shown in FIGS. 2 and 4.

The affixing agent (6) may be any method known in the art such as, for example, an adhesive; pinning using a dowel, or annular forms molded or manufactured where one annular form has a projection, while an adjoining annular form has a recess capable of accepting the projection (e.g. a male/female configuration). Affixing the individual forms of the multi-layered seal ring (1) allows them to retain the ability to slide relative to one another for the purpose of expansion for installation of the multi-layered ring, while not rotating relative to one another.

Dowels used in the present invention must be made from a strong material capable of be formed into small cross sectional pins. The dowel must be of a size that it is stiff enough to withstand its insertion into the respective holes in the individual annular forms as well as being capable of withstanding the pressures, forces and thermal requirements of the fluid system, while not degrading the integrity of the individual annular forms of the multi-layered seal ring (1). Furthermore, the dowel must also be made from inert materials or those chemically compatible with both the annular forms and the fluid system in which it is to be used. Suitable dowels for use in the present invention include those made from small gauge wire, fiberglass, carbon fiber, stainless steel, copper, aluminum, glass, polymers etc. Preferably, the dowel diameter is no more than 50% of the wall thickness of the individual annular forms, more preferably no more than 20% of the wall thickness.

Typically the dowels are of a size that when pressed into place they maintain their positioning, however, maintaining them in position may be supplemented by the use of adhesives, such as those described below for affixing the annular forms to one another. Furthermore, a groove such as, for example, a ring groove found in some shafts, rods or other cylindrical members with which the annular forms are utilized also assists in preventing the dowel from working its way out of position. In positioning the dowel there needs to be sufficient penetration into each annular form such that the dowel holds the annular forms in contact with one another and prevents the rotation of the annular forms relative to one another, but should not extend beyond the non-adjoining planar surface of the annular form perpendicular to the end surface of the dowel.

Adhesives utilized in the present invention should not weaken (e.g. chemically degrade) the annular forms, and such adhesives may be applied manually or using any method known in the art for such applications. The portion of the multi-layered seal ring (1) where the individual annular forms are affixed to one another is the affixation zone (5), which is generally a small area in relation to the overall circumference of the multi-layered seal ring. Typically with the use of adhesives, the size (or width) of the affixation zone is kept as small as possible where it is kept as close to the circumferential mid-point of the annular forms between the gaps (4) or fractures (12), while still being able to affix the individual annular or non-annular forms to one another. Any applied adhesive should not extrude from between the adjoining annular forms, so care must be taken in the amount applied. Over-application of an adhesive may interfere with the sealing capabilities of the multi-layered structure and could also break-off and become a contaminant to the rest of the fluid system.

Generally, when determining the positioning of the affixation zone, it is located at the mid-point of the centerline between the gaps (4) or fractures (12). Preferably, the affixation zone is located 90 degrees from the location of the gaps (4) or fractures, when such gaps (4) or fractures (12) are 180 degrees apart.

Suitable adhesives for use in the present invention are well known to those skilled in the art, and are typically chemically inert and have a temperature rating appropriate for the particular application in which they are to be utilized. Suitable adhesives are also commercially available such as, for example, Loctite®, available from the Henkel Loctite Corporation, Rocky Hill Conn.

The individual annular forms according to the present invention may be produced by various methods known in the art such, for example, injection molding, extrusion molding, compaction formed and the like.

The methods for making the individual at least first (2) and second (3) annular forms having a fracture (12) according to the present invention are well known in the art, including but not limited to that set forth in Attorney Docket AD7059 (E.I. Dupont de Nemours and Company).

The present invention also relates to a process for forming a multi-layered seal ring according to the present invention, the process comprising affixing at least a first annular form having a gap or fracture therein and second annular form having a gap or fracture therein to one another at an affixation zone with an affixing agent, wherein the at least first annular form is contiguous with (or adjoining to) the second annular form. The above-noted process may also be utilized for affixing non-annular forms to form multi-layered seal structures.

1. A multi-layered seal ring comprising:
a.) a first annular form having a gap therein; and
b.) a second annular form having a gap therein, wherein the second annular form is contiguous with or adjoining to the first annular polymeric form;
wherein the first and second annular forms are affixed to one another at an affixation zone with an affixing agent.

2. The multi-layered seal ring according to claim 1, wherein the first and second annular forms comprise a polymer, a metal or flexible elastomer.

3. The multi-layered seal ring according to claim 2, wherein the polymer is a polyimide, polyamide, polyester, polyether ether ketone, polyamide imide, polyether imide, polyether ketone ketone, polyether ketone, polyphenylene sulfide, polybenzimidazole, and thermoplastic polyimide, polytetrafluoroethylene, or liquid crystal polymer.

4. The multi-layered seal ring according to claim 3, wherein the polyimide is prepared from at least one diamine and at least one anhydride.

5. The multi-layered seal ring according to claim 4, wherein the diamine is m-phenylene diamine, p-phenylene diamine, oxydianiline, methylene dianiline, toulene diamine and mixtures thereof.

6. The multi-layered seal ring according to claim 5, wherein the diamine is 4,4′-oxydianiline.

7. The multi-layered seal ring according to claim 4, wherein the anhydride is benzophenone tetracarboxylic dianhydride, biphenyl dianhydride, trimellitic anhydride, pyromellitic dianhydride, maleic anhydride, nadic anhydride and mixtures thereof.

8. The multi-layered seal ring according to claim 7, wherein the anhydride is pyrometillitic dianhydride.

9. The multi-layered seal ring according to claim 4, wherein the polyimide is BTDA-MPD, MA-MDA, BTDA-MDA-NA, TMA-MPD & TMA-ODA, BPDA-ODA, BPDA-MPD, BPDA-PPD, BTDA-4, 4′-diaminobenzophenone or BTDA-bis(P-phenoxy)-p, p′-biphenyl.

10. The multi-layered seal ring according to claim 1, wherein the first and second annular forms comprise a polyimide composition comprising a blend of at least one polyimide with at least one other polymer which is melt processibile at a temperature of less than about 400° C. and is selected from polyamide and polyester resin and may be present in a concentration of from about 45 to 79.9 weight percent.

11. The multi-layered seal ring according to claim 3, wherein the polyamides is nylon 6, nylon 6,6, nylon 610 and nylon 612.

12. The multi-layered seal ring according to claim 3, wherein the polyester is polybutylene terepthalate and polyethylene terepthalate.

13. The multi-layered seal ring according to claim 3, wherein the liquid crystal polymer includes polyesteramides and polyesterimdes.

14. The multi-layered seal ring according to claim 1, wherein the first and second annular forms comprise the same polymer.

15. The multi-layered seal ring according to claim 1, wherein the first and second annular forms comprise different polymers.

16. The multi-layered seal ring according to claim 1, wherein the first and second annular forms have a tensile strength in the range of about 9000 to about 18000 psi.

17. The multi-layered seal ring according to claim 1, wherein the first and second annular forms have an elongation in the range of about 2.5% to about 10%.

18. The multi-layered seal ring according to claim 1, wherein the first and second annular forms have a tensile modulus in the range of about 310,000 to about 750,000 psi.

19. The multi-layered seal ring according to claim 2, wherein the polymer further comprises additives, fillers or dry lubricants.

20. The multi-layered seal ring according to claim 1, wherein the gaps in the first and second annular forms are about 180 degrees apart.

21. The multi-layered seal ring according to claim 1, wherein the affixing agent is a dowel, adhesive, or projection/recess configuration formed into the first and second annular forms.

22. The multi-layered seal ring according to claim 21, wherein the dowel comprises wire, fiberglass, carbon fiber, stainless steel, copper, aluminum, glass or polymer.

23. A compressor comprising the multi-layered seal ring according to claim 1.

24. A power steering device comprising the multi-layered seal ring according to claim 1.

25. An automatic transmission comprising the multi-layered seal ring according to claim 1.

26. A multi-layered seal structure comprising:
a.) a first non-annular form having a gap therein; and
b.) a second non-annular form having a gap therein, wherein the second annular form is contiguous with the first annular polymeric form;
wherein the first and second annular forms are affixed to one another at an affixation zone with an affixing agent thereby forming a multi-layered seal ring.

27. The multi-layered seal structure according to claim 26, wherein the non-annular shape is elliptical.

28. A multi-layered seal ring comprising:
a.) a first annular form having a fracture therein; and
b.) a second annular form having a fracture therein, wherein the second annular form is contiguous with or adjoining to the first annular polymeric form;
wherein the first and second annular forms are affixed to one another at an affixation zone with an affixing agent.

29. The multi-layered seal ring according to claim 28, wherein the fracture in the first and second annular forms are about 180 degrees apart.

30. A multi-layered seal structure comprising:
a.) a first non-annular form having a fracture therein; and
b.) a second non-annular form having a fracture therein, wherein the second non-annular form is contiguous with or adjoining to the first non-annular polymeric form;
wherein the first and second non-annular forms are affixed to one another at an affixation zone with an affixing agent.

31. A process for forming a multi-layered seal ring comprising:
(i) affixing at least a first annular form having a gap or fracture therein and second annular form having a gap or fracture therein to one another at an affixation zone with an affixing agent, wherein the at least first annular form is contiguous with or adjoining to the second annular form.

32. A process for forming a multi-layered seal structure comprising:
(i) affixing at least a first non-annular form having a gap or fracture therein and second non-annular form having a gap or fracture therein to one another at an affixation zone with an affixing agent, wherein the at least first non-annular form is contiguous with or adjoining to the second non-annular form.
